(19) United States
(12) Patent Application Publication
(10) Pub. No.: US 2016/0069407 A1
(43) Pub. Date: Mar. 10, 2016

(54) LINING CARRIER PLATE FOR A BRAKE LINING

(71) Applicant: TMD FRICTION SERVICES GMBH, Leverkusen (DE)

(72) Inventors: Axel STENKAMP, Bonn (DE); Dai-Victor SAKAGUCHI, Gruendau (DE)

(21) Appl. No.: 14/413,270

(22) PCT Filed: Jul. 9, 2013
(86) PCT No.: PCT/EP2013/064458

§ 371 Date: Mar. 24, 2015

(30) Foreign Application Priority Data
Jul. 10, 2012 (DE) 10 2012 106 162.9

(51) Int. Cl. F16D 65/78; F16D 65/092

(52) U.S. Cl. CPC F16D 65/78; F16D 65/092

(57) ABSTRACT

A lining carrier plate (2) of a brake shoe, which is designed for holding a friction lining, wherein the lining carrier plate (2) has a first part (4) made of a first metal having a first coefficient of thermal expansion, and at least ene a second part (6) that is mechanically joined to the first part (4) and is made of a second metal having a second coefficient of thermal expansion, wherein the first coefficient of thermal expansion and the second coefficient of thermal expansion are different, and the first part (4) is configured as an insert that is mechanically joined with the second part (6), and in that the first part (4) penetrates through the second part (6).

### CROSS-REFERENCE TO RELATED APPLICATIONS

This application is a national stage application (under 35 USC §371) of PCT/EP2013/064458, filed Jul. 9, 2013, which claims benefit of German application 10 2012 106 162.9, filed Jul. 10, 2012.

### BACKGROUND OF THE INVENTION

### Technical Field and State of the Art

The invention relates to a lining carrier plate for a brake shoe, said lining carrier plate being configured to hold a friction lining.

Lining carrier plates for brake shoes of the above-mentioned type are known from the state of the art. The lining carrier plates, especially those for brake shoes of disc brakes, often have very similar basic structures. A friction lining is applied onto such a lining carrier plate by means of, for instance, an adhesive layer.

During braking, the friction lining establishes frictional contact with a brake disc or a brake drum, thereby converting kinetic energy into thermal energy. Due to the rise in temperature, the brake disc and the brake shoes expand and also become deformed under certain circumstances, not only causing changes in the friction properties of the friction elements due to the rise in temperature, but also having an additional impact on the braking behavior owing to the changed pressure distribution.

Before this backdrop, it has been ascertained in conventional disc brakes that, in an undesired manner, small areas having a high temperature, so-called hot spots, can be formed via which an excessively high portion of the braking pressure is applied onto a relatively small surface area. Possible consequences of this include greater wear and tear, more squeaking of the brakes, and an overall diminished braking performance.

German patent application DE 10 2005 048 109 A1 discloses a brake shoe for a disc brake, comprising a carrier that has a heat-insulating, porous pressure-transfer element made of fibers bonded with synthetic resin onto the side facing the piston of a brake cylinder. The pressure-transfer element is inserted into a recess in the carrier for the brake lining. The pressure-transfer element is made of cast fiber material. This is meant to reduce the heat transfer to the brake fluid.

German utility model DE 20 2009 012 778 U1 discloses a composite brake block shoe and a composite brake block, whereby the composite brake block shoe has a plate-shaped base element with a support surface on the inside for a plastic compound of the composite brake block, whereby the base element has at least one steel insert. The steel insert extends essentially over the entire length of the base element and it has a non-rectangular cross section, preferably a circular cross section.

German patent application DE 10 2008 024 194 A1 discloses a brake lining module for bicycle disc brakes having a friction brake lining and a backplate. The backplate consists of a first layer, which is deposited on the friction brake lining, and of a second layer, which is deposited on the first layer. The first layer is made of an aluminum alloy, while the second layer is made of stainless steel. The backplate has thickness of about 1.7 mm to 1.8 mm.

U.S. Pat. Appln. No. 2012/0000735 A1 discloses a brake shoe having cooling surfaces for a bicycle brake. The cooling plate has sections with cooling fins that serve to dissipate heat. A brake lining having a brake lining surface is mechanically attached to an attachment area of the cooling plate. The brake lining consists of a friction lining which is rigidly and firmly joined to form a monolithic element on a lining carrier plate. The attachment area consists of a metal that conducts heat well, preferably brass, aluminum or alloyed steel. The brake lining has rivet sections to be attached to the cooling plate as well as to an attachment plate.

U.S. Pat. Appln. No. 2004/0099493 A1 discloses a friction lining for disc brakes for road and rail vehicles that has a carrier plate made of steel with a thin-walled rough ground carrier made of a metal sheet as well as an interlayer with a functional block fastened thereon made of a friction material.

The friction lining carrier is provided with at least one window-like cutout. Filler material or insulating material, preferably plastic, can be inserted into this cutout. Metallic filler materials or insulating materials are provided in order to increase or improve the heat flow. It is likewise provided that sections of the rough ground carrier are pressed into the window-like cutouts. The rough ground carrier can be additionally welded to the friction lining carrier.

U.S. Pat. Appln. No. 2006/0124405 A1 discloses a disc brake that can be actuated pneumatically and/or by an electric motor, comprising a brake caliper that extends over a brake disc, at least an adjuster device arranged in the brake caliper for purposes of compensating for wear of the brake lining and/or brake disc by adjusting the distance between at least one brake lining and the brake disc, which encompasses two axially movable adjustment elements, each fitted with a pressure piece.

The area of the two adjustment elements of the adjuster device facing its appertaining brake lining is non-rotatably attached to a shared connection plate. A single-part or multiple-part heat-insulating layer is applied onto the side of the connection plate and/or pressure piece facing the appertaining brake lining, at least in certain areas.

It is an objective of the present invention to refine a lining carrier plate of the above-mentioned type in such a way that it exhibits optimized hot-braking behavior.

### BRIEF SUMMARY OF THE INVENTION

A lining carrier plate according to the invention for a brake shoe, said lining carrier plate being configured to hold a friction lining, has a first part made of a first metal having a first coefficient of thermal expansion, and at least one second part that is mechanically joined to the first part and that is made of a second metal having a second coefficient of thermal expansion, whereby the first coefficient of thermal expansion and the second coefficient of thermal expansion of the individual metals are different.

Examples of suitable first and second materials are steel and titanium. The coefficient of thermal expansion of steel is in the range of 11 to 25×10-6 K-1 and that of titanium is 9×10-6 K-1.

The friction lining can be affixed to the lining carrier plate by means of conventional fastening measures, for example, by gluing or vulcanization. The lining carrier plate can have any desired outer contour of the type needed by different brake systems. Possible configurations are hammerhead plates or the familiar so-called push geometry.

Owing to the mechanical connection between the first part and the second part as well as due to the differing coefficients of thermal expansion of the first part and the second part, a targeted deformation of the lining carrier plate, and thus of a correspondingly configured brake shoe, can be achieved when the lining carrier plate according to the invention heats up, so that the distribution of the braking pressure of a correspondingly configured disc brake can be influenced in a targeted manner in cases of hot-braking. The lining carrier plate according to the invention makes it possible to prevent undesired undefined temperature and load peaks.

Instead of two parts having differing coefficients of thermal expansion, it is also possible to provide several parts that are each mechanically joined to each other. These several parts can be made of two or more different metals in order to systematically influence the coefficient of thermal expansion of the lining carrier plate.

It is provided according to the invention that the first part is embedded into the second part. In this manner, for example, it can be achieved that the surface that makes contact with the friction lining can be made of metal, and this can avoid local force peaks on the friction lining due to differing coefficients of thermal expansion caused, for instance, by shear forces.

According to a first possible embodiment of the invention, it can be provided that the first part and the second part are integrally bonded together. This can be achieved, for example, by welding or gluing. Such an integral bond of the two parts permits the transmission of force over a large surface area during the deformation process.

In accordance with an alternative embodiment of the lining carrier plate according to the invention, it can be provided that the first part and the at least one second part are attached to each other. Such an attachment can be achieved by compressing, crimping, riveting, screwing or other known fastening modalities. Thanks to this attachment, the production work involved can be reduced.

According to another possible embodiment of the invention, it can be provided that the metal of the first part has a greater coefficient of thermal expansion than the metal of the second part. Consequently, when the lining carrier plate heats up, it is achieved that the first part expands to a greater extent than the second part does, as a result of which suitable deformations aimed at bringing about desired effects can be achieved by means of suitable geometries yet to be described below.

According to another possible embodiment of the invention, it can be provided that the first part and the second part are arranged one after the other as seen in the pressure direction. This results in a deformation of the outside areas of the lining carrier plates perpendicular to the pressure direction, in the pressure direction or away from the pressure direction so that, depending on the requisite application case, the lining carrier plate can be bent in such a way that the friction lining rubs to a greater or lesser extent against the friction element, for instance, a disc brake.

According to another possible embodiment of the invention, it can be provided that the first part is configured as a mechanically joined insert placed into the second part. Thus, a targeted deformation of the lining carrier plate can be achieved as a function of the geometry of the insert.

According to another possible embodiment of the invention, it can be provided that the first part penetrates through the second part. On the one hand, this facilitates the mechanical joining of the first part to the second part and, on the other hand, it allows additional expansion characteristics.

According to another possible embodiment of the invention, it can be provided that the first part is arranged on the inside, lengthwise with respect to the pressure direction, so that the first part is arranged on a side facing away from the friction lining.

A first independent subject matter of the invention relates to a brake shoe having a friction lining and a lining carrier plate according to the inventive idea described above.

Additional objectives, features and advantageous application possibilities of the invention ensue from the description below of an embodiment with reference to the drawings. In this context, all of the described and/or depicted features, either on their own or in any meaningful combination, constitute the subject matter of the present invention, also irrespective of their compilation in the claims or the claims to which they refer back.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

The invention will be explained on the basis of an embodiment. The following is shown here in schematic form:

FIGS. 1A,1B a top view and a perspective view of a lining carrier plate according to the invention;

FIG. 2 a view of the high-temperature pressure distribution of a conventional friction lining as well as

FIG. 3 a view of the high-temperature pressure distribution of a friction lining of a brake shoe according to the invention.

### DETAILED DESCRIPTION OF THE INVENTION

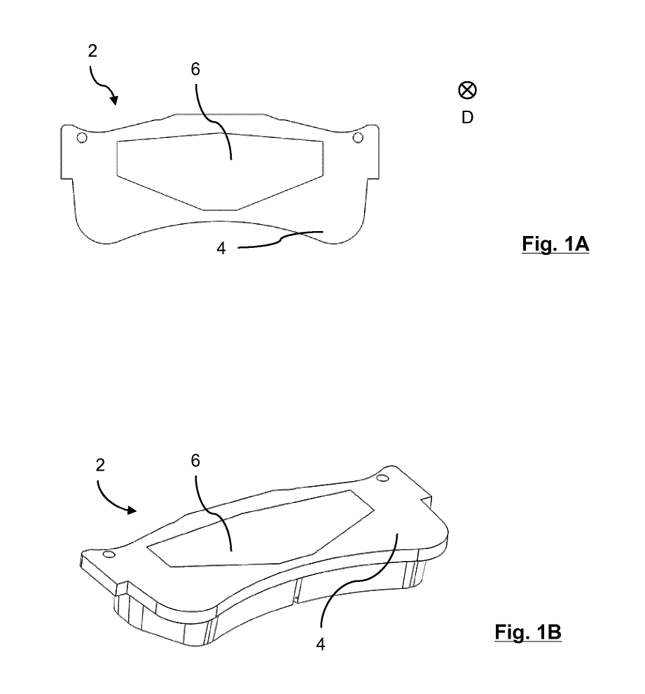

FIGS. 1A, 1B show a top view (FIG. 1A) and a perspective view (FIG. 1B) of a lining carrier plate 2 according to the invention.

The lining carrier plate 2 has two parts 4, 6 made of two different metals, the part 6 is made of titanium and the part 4 is made of steel, said parts being mechanically joined to each other. In the embodiment shown, the first part 4 is inserted into the second part 6 and welded in place.

The first part 4 has a greater coefficient of thermal expansion than the second part 6. Here, the first part 4 is configured as a triangle, especially as an isosceles triangle. Other geometries, for example, rectangular or strip-like configurations are likewise conceivable within the scope of the invention.

In the embodiment shown, the first part 4 is configured so as to penetrate in the pressure direction D, although it can also be configured as a single part that is arranged only on one side of the lining carrier plate 2 according to the invention.

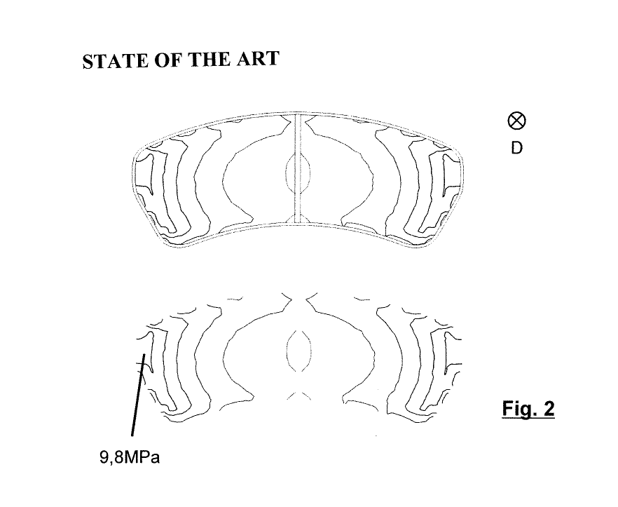

FIG. 2 shows a conventional friction lining according to the state of the art as well as its coefficient of thermal expansion (top depiction) and the pressure distribution resulting from this (bottom depiction).

The coefficient of thermal expansion of the conventional brake shoe is greatest in the edge area perpendicular to the pressure direction D, thus leading to pressure distributions of 9.2 megapascals at the maximum in the edge areas in the depicted embodiment.

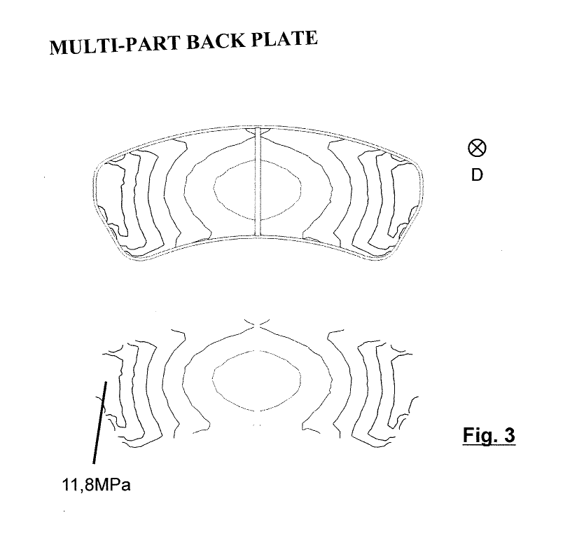

In a lining carrier plate according to the invention, as shown in FIG. 3, the use of an at least two-part lining carrier plate accounts for a greater deformation in the edge areas, so that, under otherwise identical boundary conditions, the pressure here can reach 9.5 megapascals at the maximum, as is the case in the embodiment in FIG. 2.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

### LIST OF REFERENCE NUMERALS

2 lining carrier plate
4 first part
6 second part
D pressure direction

1. A lining carrier plate (2) for a brake shoe, said lining carrier plate (2) being configured to hold a friction lining, comprising:
a first part (4) made of a first metal having a first coefficient of thermal expansion; and
at least a second part (6) that is mechanically joined to the first part (4) and that is made of a second metal having a second coefficient of thermal expansion,
wherein the first coefficient of thermal expansion and the second coefficient of thermal expansion are different, and
wherein the first part (4) is configured as an insert that is mechanically joined to the second part (6), and the first part (4) penetrates through and is embedded into the second part (6).

2. The lining carrier plate according to claim 1, wherein the first part (4) and the second part (6) are integrally bonded together.

3. The lining carrier plate according to claim 1, wherein the first part (4) and the second part (6) are attached to each other.

4. The lining carrier plate according to claim 1, wherein metal of the first part (4) has a greater coefficient of thermal expansion than the metal of the second part (6).

5. The lining carrier plate according to claim 1, wherein the first part (4) and the second part (6) are arranged one after the other as seen in the pressure direction (D).

6. (canceled)

7. The lining carrier plate according to claim 1, wherein the first part (4) is arranged on the inside, lengthwise with respect to the pressure direction (D).

8. A brake shoe having a friction lining and a lining carrier plate (2) according to claim 1.

9. A brake shoe, comprising:
a friction lining; and
a lining carrier plate, said lining carrier plate comprising (a) a first part made of a first metal having a first coefficient of thermal expansion, and (b) at least a second part made of a second metal having a second coefficient of thermal expansion that is different from the first coefficient of thermal expansion, wherein the first part penetrates through and is embedded into the second part.
